(19) United States
(12) Patent Application Publication
(10) Pub. No.: US 2025/0026185 A1
(43) Pub. Date: Jan. 23, 2025

(54) VEHICULAR REAR SLIDER WINDOW ASSEMBLY WITH WIRELESS ELECTRICAL POWERING OF MOVABLE PANEL HEATER GRID

(71) Applicant: Magna Exteriors, Inc., Troy, MI (US)

(72) Inventors: Darin J. Snider, Holland, MI (US); David L. Guillozet, Hamilton, MI (US)

(21) Appl. No.: 18/776,343

(22) Filed: Jul. 18, 2024

Related U.S. Application Data
(60) Provisional application No. 63/514,810, filed on Jul. 21, 2023.

(51) Int. Cl. B60J 1/18; B60S 1/02

(52) U.S. Cl. CPC B60J 1/1853; B60S 1/026

(57) ABSTRACT

A vehicular rear slider window assembly includes a fixed window panel, a movable window panel, and a frame portion fixed relative to the fixed window panel. The fixed window panel has an opening, and the movable window panel is movable along upper and lower rails of the frame portion between a closed position and an opened position. Electrically conductive traces are established at a surface of the fixed window panel, and electrically conductive traces are established at a surface of the movable window panel. Electrical power to the electrically conductive traces of the movable window panel is provided wirelessly throughout all positions of the movable window panel between and including the opened position and the closed position.

### CROSS REFERENCE TO RELATED APPLICATION

The present application claims the filing benefits of U.S. provisional application Ser. No. 63/514,810, filed Jul. 21, 2023, which is hereby incorporated herein by reference in its entirety.

### FIELD OF THE INVENTION

The present invention relates generally to movable or slider window assemblies for vehicles and, more particularly to a side or rear slider window assembly for a vehicle having a heating element or feature.

### BACKGROUND OF THE INVENTION

It is known to provide a slider window assembly for an opening of a vehicle, such as a rear slider window assembly for a rear opening of a pickup truck. Conventional slider window assemblies for rear openings of trucks or the like typically include three or more panels, such as two fixed window panels and a slidable window panel. The slidable window panel is supported by rails and may be moved along the rails to open and close the window. It is also known to provide a heating element at the window assembly to defog or defrost the window panels. The window panels typically include respective heater grids that are electrically connected to a power source and are heated responsive to actuation of a user input.

### SUMMARY OF THE INVENTION

A vehicular rear slider window assembly provides for defogging or defrosting of the window panel or panels of the rear slider window assembly via electrically conductive traces or heater grids at one or more window panels of the rear slider window assembly. The heater grids are disposed at a surface of the fixed and movable window panels and comprise electrically conductive traces or busbars at which electrical connectors are disposed for electrically connecting the busbars and heater grids to a wire harness of the vehicle. Electrical power to the electrically conductive traces of the movable window panel is provided wirelessly throughout all positions of the movable window panel between and including the opened position and the closed position.

For example, a transmitter may be disposed at the frame portion and a receiver may be disposed at the movable window panel. The transmitter, when operated, generates a magnetic field at or near the receiver, and the receiver, responsive to the magnetic field, generates electrical voltage for powering the electrically conductive traces of the movable window panel. The transmitter may include a plurality of transmitting elements disposed along the lower rail of the frame portion, and the receiver may include a plurality of receiving elements disposed along a lower perimeter region of the movable window panel. The plurality of transmitting elements may be embedded or integrated into the lower rail, and the plurality of receiving elements may be embedded or integrated into a carrier at the lower perimeter region of the movable window panel.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly;

FIG. 2 is a plan view of the rear slider window assembly;

FIG. 3 is a perspective view of the movable window panel assembly and transmitters and receivers for electrically powering the heater grid of the movable window panel;

FIG. 4 is an exploded perspective view of part of the rear slider window assembly; and

FIG. 5 is another exploded perspective view of the rear slider window assembly.

### DESCRIPTION OF THE PREFERRED EMBODIMENTS

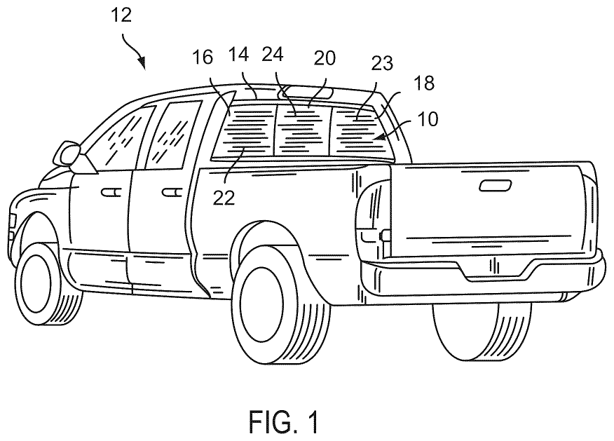

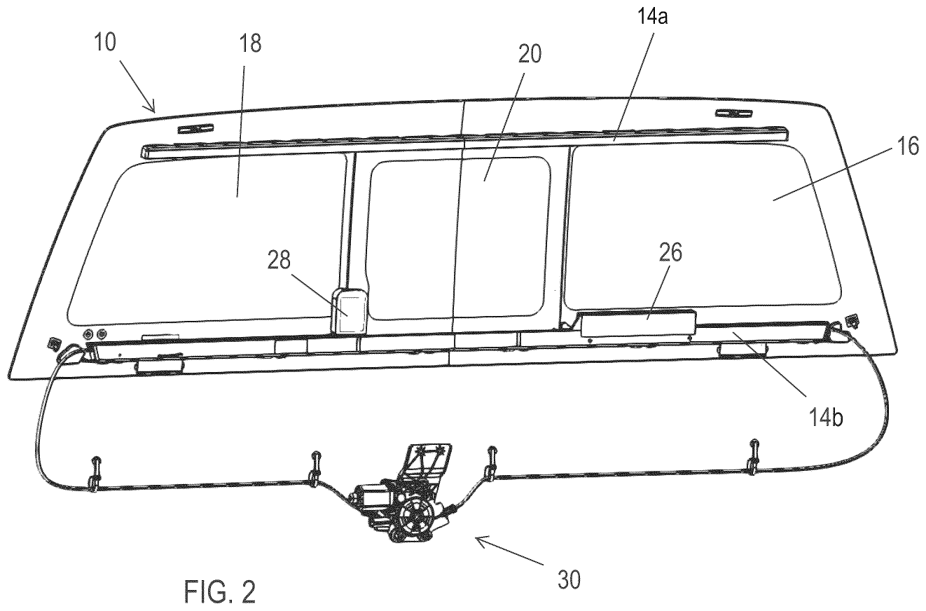

Referring now to the drawings and the illustrative embodiments depicted therein, a rear slider window assembly 10 of a vehicle 12 (such as a pickup truck or the like) includes a window frame 14 (having an upper rail 14a and a lower rail 14b), a pair of side fixed window panels 16, 18 and a movable window panel 20 that is movable relative to the frame 14 and the fixed window panels 16, 18 between an opened position and a closed position (FIGS. 1 and 2). The fixed window panels 16, 18 may be spaced from one another to define an opening or aperture between the fixed window panels 16, 18. Optionally, the window assembly includes a single fixed window panel having an opening between opposing sides or portions of the fixed window panel. In the closed position, the movable window panel 20 is disposed at the opening between the fixed window panels 16, 18 (or at the opening between the sides or portions of the singular fixed window panel). In the opened position, the movable window panel 20 is disposed at least partially along one of the fixed window panels 16, 18 (or along one side or portion of the singular fixed window panel).

The fixed window panels 16, 18 each include an electrically conductive heater grid 22, 23 or other heating element or electrically operable element established at the window panels 16, 18 (such as at or on an interior surface of the window panels), and the movable window panel 20 includes an electrically conductive heater grid or other heating element or electrically operable element 24 established at the window panel 20 (such as at or on an interior surface of the movable window panel). In other words, one fixed window panel 16 includes an electrically conductive heater grid 22, the other fixed window panel 18 includes an electrically conductive heater grid 23, and the movable window panel 20 includes an electrically conducive heater grid 24, where the heater grids may be disposed at the respective interior surfaces of the window panels.

The heater grids 22, 23 at the fixed window panels 16, 18 are electrically conductively connected to (or are otherwise in electrical conductive continuity with) a power source of the vehicle and may be powered (such as responsive to a user actuatable input or switch or button of the vehicle or responsive to a sensor or accessory of the vehicle) to heat or defrost or defog the fixed window panels 16, 18. The movable panel heater grid 24 is electrically powered via the vehicle power source and is electrically powered to heat or defrost or defog the movable window panel 20. The movable panel heater grid 24 is electrically powered via non-contacting wireless power transfer from a transmitter at the frame portion or fixed window panel to a receiver at the movable window panel 20.

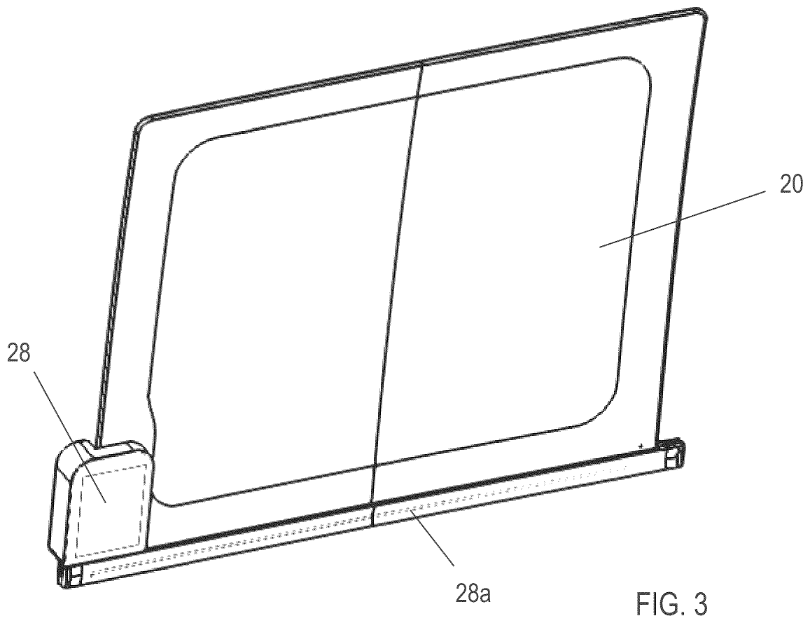

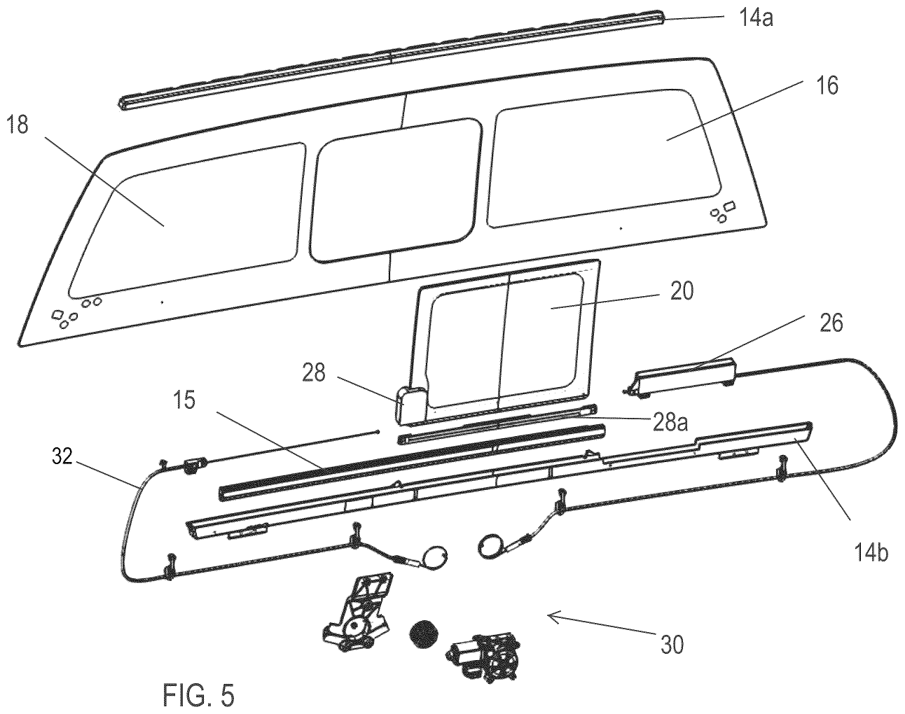

As shown in FIG. 2, the lower channel or rail 14b includes a transmitter 26 and the movable window panel includes a receiver 28. The transmitter 26, when electrically powered, generates a magnetic field via a plurality of transmitter elements disposed along the lower rail or channel 14b. When the receiver 28 is exposed to the magnetic field, the generated magnetic field induces a voltage in the receiver 28 to generate electrical power at the movable window panel 20 for powering the heater traces. The transmitter elements or electrodes may be disposed along and within the lower rail 14b (e.g., along a slider channel 15 (FIG. 5) within the lower rail 14b) so that the receiving elements or electrodes 28a of the receiver 28 (FIG. 3) of the movable panel 20 are at or alongside a portion of the transmitter elements at all locations of the movable window panel 20 between the closed position and the opened position. Thus, electrical powering of the movable panel heater grid 24 is provided and maintained at any position of the movable window panel 20 between the closed position and the opened position.

Put another way, the transmitter 26 includes one or more transmitter elements or electrodes spaced from one another along the lower rail 14b so that, when the transmitter 26 is electrically operated, the magnetic field generated by the transmitter 26 spans a region configured to overlap or include at least one receiving element or electrode 28a of the receiver 28 throughout the range of motion of the movable window panel 20. As the movable panel 20 moves between the closed position and the opened position, the receiving elements 28a may move relative to the transmitting elements and within the generated magnetic field. When at least one receiving element 28a of the receiver 28 is disposed within the magnetic field of the transmitter 26, the receiver 28 generates electrical power for energizing the heater grid 24 at the movable panel 20. Thus, the receiver 28 is able to generate electrical power responsive to the magnetic field generated by the transmitter 26 with the movable window panel 20 moved to any position between the closed position and the opened position. The transmitter 26 may include a surface resonator and the receiver 28 may include a resonator to increase the transmission coefficient and thus the quality of the transmission.

The transmitter elements may be disposed along or integrated into a wall of the lower channel or rail 14b, while the receiver elements 28a may be disposed along the lower part of the movable panel 20 (e.g., and such as shown in FIG. 5, receiver elements 28a may be disposed along or integrated in a carrier or lower strip along the lower edge of the movable window panel 20). The transmitter 26 is electrically connected to control circuitry that operates to power the transmitter 26 when the movable panel heater grid 24 is to be powered (e.g., responsive to actuation of a user input in the vehicle). The receiver 28 is electrically connected to circuitry at the movable panel 20, with the circuitry electrically connected to the ends of the electrically conductive heater grid traces. Thus, when the transmitter circuitry is controlled to heat the movable panel 20, the transmitter 26 operates to generate the magnetic field and the receiver 28 generates voltage responsive to the generated magnetic field.

Accordingly, the heater grid 24 at the movable window panel 20 may be electrically powered without a wired connection between components at the movable window panel 20 and components at the fixed window panel. This allows for electrical power to be delivered to the movable window panel 20 without needing to accommodate for movement (e.g., extension and retraction) of a wired connection.

The movable or slider window panel may be movable such as via manual pushing or pulling at the window panel or in response to actuation of a drive motor of a drive motor assembly or system, which may move cables or the like to impart horizontal movement of the slider window panel along the rails. As shown in FIGS. 2 and 5, a power drive system 30 operates to move (e.g., push or pull) the movable window panel in either direction along the upper and lower channels via respective cables 32. Optionally, the drive motor assembly may utilize aspects of the drive assemblies of the types described in U.S. Pat. Nos. 4,920,698; 4,995,195; 5,146,712; 5,531,046; 5,572,376; 6,119,401; 6,955,009; 7,073,293 and/or 10,501,977, and/or U.S. Publication Nos. US-2019-0383084; US-2008-0127563 and/or US-2004-0020131, which are all hereby incorporated herein by reference in their entireties.

Optionally, a lower edge region of the movable window panel 20 may be received within one or more carriage elements slidably received along the lower rail 14b of the window frame 14. When the power drive system 30 operates to move the window panel 20 between the closed position and the opened position, the cables are moved to pull or push the carriage and movable window panel along the lower rail 14b. The receiving elements 28a of the receiver 28 may be disposed along and/or integrated with the carriage. Further, the transmitter 26 may be slidably received along the lower rail 14b and movable with the movable window panel 20 between the closed position and the opened position. For example, the transmitter 26 may be connected to or attached to the cable of the power drive system 30 (such as between an end of the cable and the carriage attached to the movable window panel). Thus, the transmitter 26 and the receiver 28 may stay within wireless communication range of one another throughout the range of motion of the movable window panel 20 between the closed position and the opened position. Aspects of the cable drive system may utilize characteristics of the window assemblies described in U.S. patent application Ser. No. 18/775,303, filed Jul. 17, 2024 (Attorney Docket DON02 P5163), which is hereby incorporated herein by reference in its entirety.

The heater grid of the movable window panel is powered in a manner that allows for heating or defogging or defrosting of the movable window panel irrespective of whether the movable window panel is opened or partially opened or closed. The heater grids (and heating connections at the fixed and movable window panels) may utilize aspects of the rear slider window assemblies described in U.S. Pat. Nos. 9,579,955; 8,881,458 and/or 8,402,695, and/or U.S. Publication Nos. US-2023-0084191 and/or US-2022-0295603, which are all hereby incorporated herein by reference in their entireties.

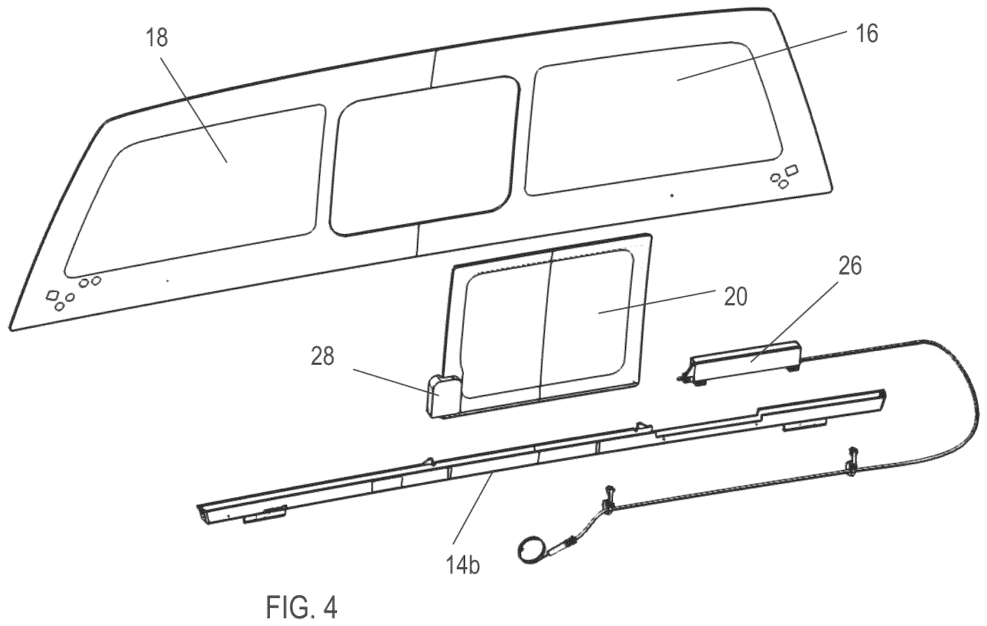

The window assembly includes two fixed window panels that are spaced apart so as to define an opening therebetween. The slider or movable window panel is movable along the lower rail and the upper rail of the frame portion to open and close the opening. Optionally, the slider window panel may be disposed at the lower carrier or carriage that receives the lower perimeter edge region of the slider window panel therein and that is slidably or movably received in the lower rail of frame portion. The two fixed window panels may comprise two separate panels with upper and lower appliques disposed above and below the aperture, or the two fixed window panels may be part of a single hole-in-glass window panel with the aperture formed therethrough (such as shown in FIGS. 2, 4 and 5).

Optionally, the window assembly or assemblies may utilize aspects of the window assemblies described in U.S. Pat. Nos. 11,331,984; 10,501,977; 8,938,914; 8,915,018; 8,881,458; 8,402,695; 8,322,073; 7,838,115; 7,332,225; 7,073,293; 7,003,916; 6,846,039; 6,691,464; 6,319,344; 6,068,719; 5,853,895 and/or 5,799,444, and/or U.S. Publication Nos. US-2021-0355737; US-2014-0047772; US-2013-0174488; US-2011-0056140; US-2006-0107600; US-2008-0127563; US-2004-0020131 and/or US-2003-0213179, which are hereby incorporated herein by reference in their entireties. Although shown and described as a horizontally movable center window that moves relative to a pair of opposite side windows (such as for applications at the rear of a cab of a pickup truck or the like), it is envisioned that the electrical connections described herein are applicable to other types of movable window assemblies, such as horizontally movable window panels that move relative to a single fixed window panel and/or frames (such as for a rear or side opening of a vehicle or the like), and/or such as vertically movable window panels that move relative to one or more fixed panels and/or frames (such as for a rear or side opening of a vehicle or the like).

Although shown and described as a rear slider window assembly, such as for a pickup truck, aspects of the rear slider window assembly are suitable for use on other vehicular window assemblies, such as rear window assemblies of vehicles that are fixed window panels (having mounting structure that is configured to mount or attach or bond at an opening at a rear of a vehicle) or that are openable window panels (such as hinged liftgates or the like). For example, the window assembly may comprise a fixed rear window or backlite for a pickup truck or sedan or SUV or the like, or may comprise a movable side window or a fixed side window or a quarter window or the like, with the electrical connectors providing electrical connection to electrically conductive elements at the window panel (such as electrically conductive traces for heater grids or electrically conductive traces for electrically powering other elements at the window panel(s), such as lights or cameras or the like), without use of solder.

Changes and modifications to the specifically described embodiments may be carried out without departing from the principles of the present invention, which is intended to be limited only by the scope of the appended claims, as interpreted according to the principles of patent law.

1. A vehicular rear slider window assembly, the vehicular rear slider window assembly comprising:
a fixed window panel;
a movable window panel;
a frame portion fixed relative to the fixed window panel, wherein the frame portion comprises an upper rail and a lower rail;
wherein the fixed window panel comprises an opening, and wherein the movable window panel is movable along the upper rail and the lower rail between (i) a closed position where the movable window panel is disposed at the opening and (ii) an opened position where the movable window panel is disposed at least partially along the fixed window panel;
electrically conductive traces established at a surface of the fixed window panel;
electrically conductive traces established at a surface of the movable window panel; and
wherein electrical power to the electrically conductive traces of the movable window panel is provided wirelessly throughout all positions of the movable window panel between and including the opened position and the closed position.

2. The vehicular rear slider window assembly of claim 1, wherein a transmitter is disposed at the frame portion and a receiver is disposed at the movable window panel, and wherein, when the transmitter is electrically operated, the transmitter generates a magnetic field at the receiver, and wherein the receiver, responsive to the magnetic field, generates electrical voltage for powering the electrically conductive traces of the movable window panel.

3. The vehicular rear slider window assembly of claim 2, wherein the transmitter comprises a plurality of transmitting elements disposed along the lower rail of the frame portion, and wherein the receiver comprises a plurality of receiving elements disposed along a lower perimeter region of the movable window panel.

4. The vehicular rear slider window assembly of claim 3, wherein individual transmitting elements of the plurality of transmitting elements are integrated into the lower rail, and wherein the plurality of receiving elements is integrated into a carrier at the lower perimeter region of the movable window panel.

5. The vehicular rear slider window assembly of claim 3, wherein, when the transmitter is electrically operated, the plurality of transmitting elements generates the magnetic field at one or more receiving elements of the plurality of receiving elements.

6. The vehicular rear slider window assembly of claim 2, wherein the transmitter is electrically connected to control circuitry that operates to electrically power the transmitter to electrically power the electrically conductive traces of the movable window panel when the electrically conductive traces of the fixed window panel are electrically powered.

7. The vehicular rear slider window assembly of claim 2, wherein the transmitter is electrically connected to control circuitry that operates to electrically power the transmitter to electrically power the electrically conductive traces of the movable window panel responsive to actuation of a user input in a vehicle equipped with the vehicular rear slider window assembly.

8. The vehicular rear slider window assembly of claim 2, wherein a carrier is disposed at a lower perimeter region of the movable window panel, and wherein the carrier is movably disposed at the lower rail to enable movement of the movable window panel between the closed position and the opened position, and wherein the receiver is disposed at the carrier.

9. The vehicular rear slider window assembly of claim 8, wherein the transmitter is movably disposed at the lower rail and movable along the lower rail according to movement of the movable window panel between the closed position and the opened position.

10. The vehicular rear slider window assembly of claim 9, wherein, as the movable window panel is moved between the closed position and the opened position, a distance between the transmitter and the receiver remains constant.

11. The vehicular rear slider window assembly of claim 8, wherein the transmitter is non-movably disposed at the lower rail, and wherein, as the movable window panel is moved between the closed position and the opened position, the receiver moves relative to the transmitter.

12. The vehicular rear slider window assembly of claim 1, wherein the vehicular rear window assembly is configured to be disposed at a rear portion of a cabin of a pickup truck.

13. A vehicular rear slider window assembly, the vehicular rear slider window assembly comprising:
a fixed window panel;
a movable window panel;
a frame portion fixed relative to the fixed window panel, wherein the frame portion comprises an upper rail and a lower rail;
wherein the fixed window panel comprises an opening, and wherein the movable window panel is movable along the upper rail and the lower rail between (i) a closed position where the movable window panel is disposed at the opening and (ii) an opened position where the movable window panel is disposed at least partially along the fixed window panel;
a carrier disposed at a lower perimeter region of the movable window panel, wherein the carrier is movably disposed at the lower rail to enable movement of the movable window panel between the closed position and the opened position;
electrically conductive traces established at a surface of the fixed window panel;
electrically conductive traces established at a surface of the movable window panel;
a transmitter disposed at the frame portion;
a receiver disposed at the carrier;
wherein, when the transmitter is electrically operated, the transmitter generates a magnetic field at the receiver, and wherein the receiver, responsive to the magnetic field, generates electrical voltage for powering the electrically conductive traces of the movable window panel;
wherein the transmitter is electrically connected to control circuitry that operates to electrically power the transmitter to electrically power the electrically conductive traces of the movable window panel when the electrically conductive traces of the fixed window panel are electrically powered; and
wherein electrical power to the electrically conductive traces of the movable window panel is provided wirelessly throughout all positions of the movable window panel between and including the opened position and the closed position.

14. The vehicular rear slider window assembly of claim 13, wherein the transmitter comprises a plurality of transmitting elements disposed along the lower rail of the frame portion, and wherein the receiver comprises a plurality of receiving elements disposed along the carrier at the lower perimeter region of the movable window panel.

15. The vehicular rear slider window assembly of claim 14, wherein individual transmitting elements of the plurality of transmitting elements are integrated into the lower rail, and wherein the plurality of receiving elements is integrated into the carrier at the lower perimeter region of the movable window panel.

16. The vehicular rear slider window assembly of claim 14, wherein, when the transmitter is electrically operated, the plurality of transmitting elements generates the magnetic field at one or more receiving elements of the plurality of receiving elements.

17. The vehicular rear slider window assembly of claim 13, wherein the control circuitry operates to electrically power the transmitter to electrically power the electrically conductive traces of the movable window panel responsive to actuation of a user input in a vehicle equipped with the vehicular rear slider window assembly.

18. The vehicular rear slider window assembly of claim 13, wherein the transmitter is movably disposed at the lower rail and movable along the lower rail according to movement of the movable window panel between the closed position and the opened position.

19. The vehicular rear slider window assembly of claim 18, wherein, as the movable window panel is moved between the closed position and the opened position, a distance between the transmitter and the receiver remains constant.

20. The vehicular rear slider window assembly of claim 18, wherein the transmitter is non-movably disposed at the lower rail, and wherein, as the movable window panel is moved between the closed position and the opened position, the receiver moves relative to the transmitter.

21. The vehicular rear slider window assembly of claim 13, wherein the vehicular rear window assembly is configured to be disposed at a rear portion of a cabin of a pickup truck.
